(19) United States
(12) Patent Application Publication
(10) Pub. No.: US 2024/0334212 A1
(43) Pub. Date: Oct. 3, 2024

(54) APPARATUS AND METHOD TO HANDLE WIRELESS ASYNCHRONOUS SIGNAL FOR NETWORK CONTROLLED REPEATER IN NEXT GENERATION MOBILE WIRELESS COMMUNICATION SYSTEMS

(71) Applicant: Samsung Electronics Co., Ltd., Suwon-si (KR)

(72) Inventor: June HWANG, Suwon-si (KR)

(21) Appl. No.: 18/622,619

(22) Filed: Mar. 29, 2024

(30) Foreign Application Priority Data
Mar. 30, 2023 (KR) 10-2023-0042102

(51) Int. Cl. H04W 24/04; H04W 40/02; H04W 84/04

(52) U.S. Cl. CPC H04W 24/04; H04W 40/02; H04W 84/047

(57) ABSTRACT

A method performed by a network controlled repeater (NCR) including an NCR mobile termination (NCR-MT) and an NCR forwarding (NCR-FWD) in a wireless communication system is provided. The method includes receiving, by the NCR-MT, side control information from a base station, detecting a beam failure for the NCR-MT, ceasing, by the NCR-FWD, a forwarding based on a detection of the beam failure, identifying a completion of a beam failure recovery, and resuming the forwarding using the side control information received before the detection of the beam failure based on the completion of the beam failure recovery.

### CROSS REFERENCE TO RELATED APPLICATION

This application is based on and claims priority under 35 U.S.C. § 119(a) of a Korean Patent Application No. 10-2023-0042102, filed on Mar. 30, 2023, in the Korean Intellectual Property Office, the disclosure of which is incorporated by reference herein in their entirety.

### BACKGROUND

### 1. Field

The disclosure relates to the operation of a terminal in a wireless communication system. Specifically, the disclosure relates to a wireless repeater controlled by a base station.

### 2. Description of the Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

As various services can be provided as described above and with the development of mobile communication systems, there is a need for a method to effectively provide these services.

### SUMMARY

The disclosure is to provide a method for defining an operation of a forwarding entity when an out-of-sync indicator occurs for a network controlled repeater, and performing an operation of the forwarding entity after the out-of-sync is recovered, and an apparatus for the method.

In addition, the disclosure provides a method and apparatus for suspending or resuming forwarding of network controlled repeater forwarding (NCR-FWD).

In accordance with an embodiment of the disclosure, a method performed by a network controlled repeater (NCR) including an NCR mobile termination (NCR-MT) and an NCR forwarding (NCR-FWD) in a wireless communication system is provided. The method includes receiving, by the NCR-MT, side control information from a base station, detecting a beam failure for the NCR-MT, ceasing, by the NCR-FWD, a forwarding based on a detection of the beam failure, identifying a completion of a beam failure recovery, and resuming the forwarding using the side control information received before the detection of the beam failure based on the completion of the beam failure recovery.

In accordance with another embodiment of the disclosure, a method performed by a base station in a wireless communication system is provided. The method includes transmitting, to a network controlled repeater (NCR) including an NCR mobile termination (NCR-MT) and an NCR forwarding (NCR-FWD), side control information, wherein a forwarding ceases based on a beam failure detection between the base station and the NCR-MT, wherein a beam failure recovery is performed between the base station and the NCR, and wherein the forwarding is resumed using the side control information transmitted before the beam failure detection based on a completion of the beam failure recovery.

In accordance with another embodiment of the disclosure, a network controlled repeater (NCR) including an NCR mobile termination (NCR-MT) and an NCR forwarding (NCR-FWD) in a wireless communication system is provided. The NCR includes a transceiver, and at least one processor configured to receive, from a base station, side control information, detect a beam failure for the NCR-MT, cease a forwarding based on a detection of the beam failure, identify a completion of a beam failure recovery, and resume the forwarding using the side control information received before the detection of the beam failure based on the completion of the beam failure recovery.

In accordance with another embodiment of the disclosure, a base station in a wireless communication system is provided. The base station includes a transceiver, and at least one processor configured to transmit, to a network controlled repeater (NCR) including an NCR mobile termination (NCR-MT) and an NCR forwarding (NCR-FWD), side control information, wherein a forwarding ceases based on a beam failure detection between the base station and the NCR-MT, wherein a beam failure recovery is performed between the base station and the NCR, and wherein the forwarding is resumed using the side control information transmitted before the beam failure detection based on a completion of the beam failure recovery.

According to an embodiment of the disclosure, the network controlled repeater may perform a repeating operation through optimal configuration after starting the T310 timer.

In addition, according to an embodiment of the disclosure, by using the side control information received before MT autonomous OFF after resuming forwarding of NCR-FWD, the operation of FWD can be resumed as quickly as possible to quickly provide valid services to serving terminals.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure in LTE system according to an embodiment of the disclosure;

FIG. 2 illustrates a radio protocol structure in an LTE system according to an embodiment of the disclosure;

FIG. 3 illustrates a structure in a next-generation mobile communication system according to an embodiment of the disclosure;

FIG. 4 illustrates a radio protocol structure in a next-generation mobile communication system according to an embodiment of the disclosure;

FIG. 5 illustrates a structure of a terminal in a wireless communication system according to an embodiment of the disclosure;

FIG. 6 is a block diagram illustrating a configuration of a base station in a wireless communication system according to an embodiment of the disclosure;

FIG. 7 illustrates a structure of a NCR according to an embodiment of the disclosure;

FIG. 8 illustrates a method of the operation of a T310 timer according to an embodiment of the disclosure;

FIG. 9 illustrates an NCR-FWD operation method in conjunction with T310 timer operation according to an embodiment of the disclosure;

FIG. 10 illustrates a method for resuming a FWD ON operation according to an embodiment of the disclosure;

FIG. 11 illustrates another method for resuming a FWD ON operation according to an embodiment of the disclosure;

FIG. 12 illustrates a method of maintaining configurating information for an ON/OFF state of FWD according to an embodiment of the disclosure; and

FIG. 13 illustrates a flowchart of a method for NCR according to an embodiment of the disclosure.

### DETAILED DESCRIPTION

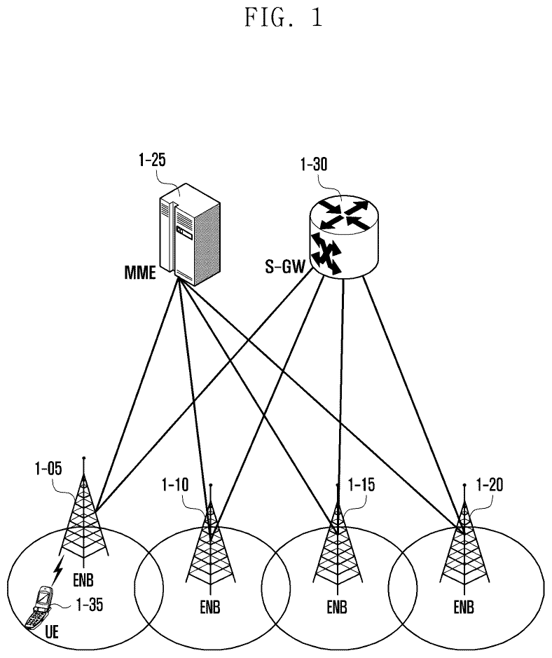

FIGS. 1 through 13, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

Embodiments of the disclosure are described with reference to the accompanying drawings.

Throughout the specification, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, a BS is an entity that allocates resources to terminals, and may be at least one of a gNode B, an eNode B, a Node B, a BS, a wireless access unit, a BS controller, and a node on a network. A terminal may include a UE, a mobile station (MS), a cellular phone, a smartphone, a computer, or a multimedia system capable of performing communication functions. In the disclosure, a “downlink” refers to a radio link via which a BS transmits a signal to a terminal, and an “uplink” refers to a radio link via which a terminal transmits a signal to a BS. Further, although the following description may be directed to a long term evolution (LTE) or LTE-A system by way of example, embodiments of the disclosure may also be applied to other communication systems having similar technical backgrounds or channel types to the embodiments of the disclosure. Examples of other communication systems may include 5G new radio (NR) developed beyond LTE-A, and in the following description, “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create a means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed concurrently or the blocks may sometimes be executed in the reverse order, depending upon the functionality involved.

As used herein, “unit” refers to a software element or a hardware element, such as a field programmable gate array (FPGA) or an application specific integrated circuit (ASIC), which performs a predetermined function. However, the term “unit” does not always have a meaning limited to software or hardware. “Unit” may be constructed either to be stored in an addressable storage medium or to execute one or more processors. Therefore, “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may either be combined into a smaller number of elements, or a “unit,” or divided into a larger number of elements, or a “unit.” Moreover, the elements and “units” may be implemented to reproduce one or more CPUs within a device or a security multimedia card. Further, the term “unit” in the embodiments may include one or more processors.

In the following description, the disclosure will be described using terms and names defined in 5GS and NR standards, which are standards defined by the 3rd generation partnership project (3GPP) organization among currently existing communication standards for the convenience of description. However, the disclosure is not limited by these terms and names, and may be applied in the same way to wireless communication networks that conform other standards. For example, the disclosure can be applied to 3GPP 5GS/NR (5th generation mobile communication standard).

FIG. 1 illustrates a structure in an LTE system according to an embodiment of the disclosure.

Referring to FIG. 1, a wireless access network of the LTE system may include next-generation base stations (evolved Node Bs, hereinafter, referred to as “ENBs,” “Node Bs,” or “base stations”) 1-05, 1-10, 1-15, and 1-20, a mobility management entity (MME) 1-25, and a serving-gateway (S-GW) 1-30. A user equipment (hereinafter, referred to as a “UE” or a “terminal”) 1-35 may access an external network through the ENBs 1-05 to 1-20 and the S-GW 1-30.

In FIG. 1, the ENBs 1-05 to 1-20 may correspond to the existing Node Bs of a universal mobile telecommunication system (UMTS). The ENB may be connected to the UE 1-35 via a radio channel, and may perform more complex functions than the existing Node B. In the LTE system, all user traffics including real-time services, such as voice over Internet protocol (VoIP) may be serviced through a shared channel. Accordingly, a device for collecting state information, such as buffer state information of UEs, available transmission power state information of UEs, and channel state information of UEs, and performing scheduling may be required, and each of the ENBs 1-05 to 1-20 may serve as such a device.

A single ENB may generally control multiple cells. For example, the LTE system uses a radio-access technology, such as orthogonal frequency-division multiplexing (OFDM) in a bandwidth of 20 MHz to achieve a data rate of 100 Mbps. In addition, the ENB may also apply an adaptive modulation & coding (AMC) scheme for determining a modulation scheme and a channel-coding rate in accordance with the channel state of a terminal. The S-GW 130 is a device for providing a data bearer, and may generate or release the data bearer under the control of the MME 1-25. The MME is a device for performing a mobility management function and various control functions for a terminal, and may be connected to multiple base stations.

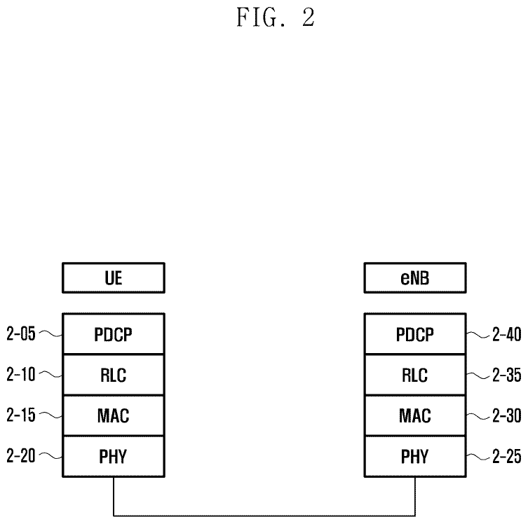

FIG. 2 illustrates a radio protocol structure in an LTE system according to an embodiment of the disclosure.

Referring to FIG. 2, the radio protocol in the LTE system includes packet data convergence protocols (PDCPs) 2-05 and 2-40, radio link controls (RLCs) 2-10 and 2-35, medium access controls (MACs) 2-15 and 2-30, and physical (PHY) devices in a terminal and an ENB, respectively. The PDCPs may perform operations of IP header compression/recovery and the like. The main function of the PDCP is summarized below but are not limited thereto:
Header compression and decompression: robust header compression (ROHC) only;
Transfer of user data;
In-sequence delivery of upper layer protocol data units (PDUs) at PDCP re-establishment procedure for RLC acknowledged mode (AM);
For split bearers in dual connectivity (DC) (only support for RLC AM): PDCP PDU routing for transmission and PDCP PDU reordering for reception;
Duplicate detection of lower layer SDUs at PDCP re-establishment procedure for RLC AM;
Retransmission of PDCP SDUs at handover and, for split bearers in DC, of PDCP PDUs at PDCP data-recovery procedure, for RLC AM;
Ciphering and deciphering; and/or
Timer-based service data unit (SDU) discard in uplink.

The radio link controls (RLCs) 2-10 and 2-35 may reconfigure the PDCP protocol data unit (PDU) at an appropriate size to perform an automatic repeat request (ARQ) operation or the like. The main functions of the RLC are summarized below but are not limited thereto:
Transfer of upper layer PDUs;
Error Correction through automatic repeat request (ARQ) (only for AM data transfer);
Concatenation, segmentation, and reassembly of RLC SDUs (only for unacknowledged mode (UM) and AM data transfer);
Re-segmentation of RLC data PDUs (only for AM data transfer);
Reordering of RLC data PDUs (only for UM and AM data transfer;
Duplicate detection (only for UM and AM data transfer);
Protocol error detection (only for AM data transfer);
RLC SDU discard (only for UM and AM data transfer); and/or
RLC re-establishment.

The MACs 2-15 and 2-30 are connected to several RLC layer devices configured in one terminal, and may perform an operation of multiplexing RLC PDUs into a MAC PDU and demultiplexing the RLC PDUs from the MAC PDU. The main functions of the MAC are summarized below but are not limited thereto:
Mapping between logical channels and transport channels;
Multiplexing/demultiplexing of MAC SDUs belonging to one or different logical channels into/from transport blocks (TB) delivered to/from the physical (PHY) layer on transport channels;
Scheduling information reporting;
Error correction through hybrid ARQ (HARQ);
Priority handling between logical channels of one UE;
Priority handling between UEs by means of dynamic scheduling;
Multimedia broadcast multicast service (MBMS) service identification;
Transport format selection; and/or
Padding.

Physical layers (PHYs) 2-20 and 2-25 may generate an OFDM symbol by performing channel-coding and modulating upper-layer data and transmit the same through a radio channel, or may perform demodulating and channel-decoding the OFDM symbol received through the radio channel and transmit the same to an upper layer.

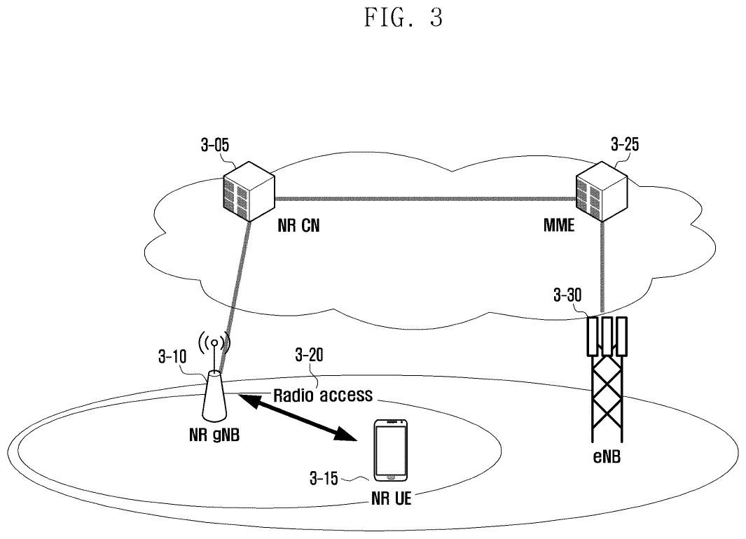

FIG. 3 illustrates a structure in a next-generation mobile communication system according to an embodiment of the disclosure.

Referring to FIG. 3, a radio access network in the next-generation mobile communication system (hereinafter referred to as “new radio (NR)” or 5G) may include a new-radio base station (a new-radio node B, hereinafter, referred to as an “NR gNB” or an “NR base station”) 3-10 and a new-radio core network (NR CN) 3-05. A new-radio user equipment (hereinafter, referred to as an “NR UE” or an “NR terminal”) 3-15 may access an external network through the NR gNB 3-10 and the NR CN 3-05.

In FIG. 3, the NR gNB 3-10 may correspond to an evolved node B (eNB) in the existing LTE system. The NR gNB 3-10 may be connected to the NR UE 3-15 through a radio channel, and thus may provide service superior to that of the existing node B. In the next-generation mobile communication system, all user traffic is serviced through shared channels in the next-generation mobile communication system. Accordingly, a device for collecting state information, such as buffer state information of UEs, available transmission power state information of UEs, and channel state information of UEs, and performing scheduling is required, and the NR gNB 3-10 may serve as such a device. A single NR gNB 3-10 may generally control multiple cells. In order to implement ultra-high-speed data transmission in the next-generation mobile communication system as compared with the existing LTE, a bandwidth that is equal to or higher than the existing maximum bandwidth may be applied. In addition, a beamforming technology may be additionally combined using orthogonal frequency-division multiplexing (OFDM) as radio connection technology.

In addition, an adaptive modulation & coding (AMC) scheme that determines a modulation scheme and a channel-coding rate in accordance with the channel state of the terminal may be applied. The NR CN 3-05 may perform a function, such as mobility support, bearer configuration, and quality of service (QoS) configuration. The NR CN 3-05 is a device that performs not only terminal mobility management functions but also various types of control functions, and may be connected to multiple base stations. Further, the next-generation mobile communication system may be linked with the existing LTE system, and the NR CN 3-05 may be connected to the MME 3-25 through a network interface. The MME 3-25 is connected to an eNB 3-30, that is, the LTE base station.

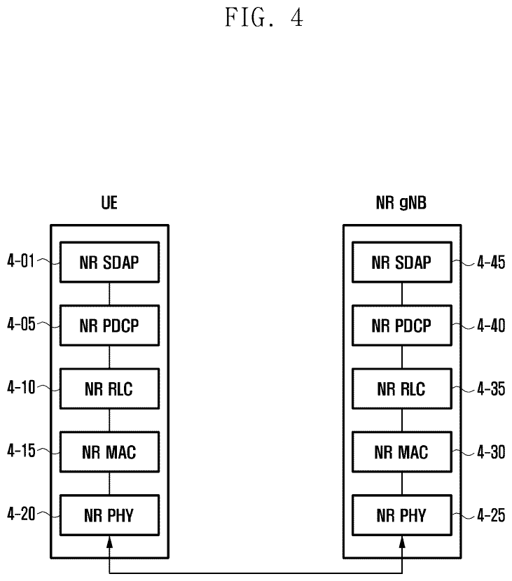

FIG. 4 illustrates a radio protocol structure in a next-generation mobile communication system according to an embodiment of the disclosure.

Referring to FIG. 4, in the radio protocol in the next-generation mobile communication system, a terminal and an NR base station may include NR service data adaptation protocols (SDAPs) 4-01 and 4-45, NR PDCPs 4-05 and 4-40, NR RLCs 4-10 and 4-35, NR MACs 4-15 and 4-30, and NR PHYs devices (or layers) 4-20 and 4-25, respectively.

The main function of the NR SDAPs 4-01 and 4-45 may include some of the following functions but are not limited thereto:
Transfer of user plane data;
Mapping between a QoS flow and a data radio bearer (DRB) for both DL and UL;
Marking QoS flow identity (ID) in both DL and UL packets; and/or
Reflective QoS flow to DRB mapping for the UL SDAP PDUs.

For an SDAP-layer device, the terminal may receive, through a radio resource control (RRC) message, a configuration as to whether to use a header of the SDAP-layer device or to use a function of the SDAP-layer device function for each PDCP layer device, each bearer, or each logical channel. When an SDAP header is configured, the terminal may be indicated to update or reconfigure, with a non-access stratum (NAS) reflective QoS 1-bit indicator and an access stratum (AS) reflective QoS 1-bit indicator of the SDAP header, mapping information for uplink and downlink QoS flows and a data bearer. According to an embodiment of the disclosure, the SDAP header may include QoS flow ID information indicating the QoS. According to an embodiment of the disclosure, the QoS information may be used as data-processing priority, scheduling information, or like in order to support a smooth service.

The main functions of the NR PDCPs 4-05 and 4-40 may include some of the following functions but are not limited thereto:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

In the above description, the reordering function of the NR PDCP device may refer to a function of sequentially rearranging PDCP PDUs received in a lower layer, based on a PDCP sequence number (SN). The reordering function of the NR PDCP device may include a function of transferring data to an upper layer in the rearranged order, a function of directly transferring data without considering an order, a function of recording lost PDCP PDUs by rearranging an order, a function of reporting a state of the lost PDCP PDUs to a transmission end, and a function of requesting retransmission of the lost PDCP PDUs.

The main function of the NR RLCs 4-10 and 4-35 may include some of the following functions but are not limited thereto:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

In the above description, the in-sequence delivery function of the NR RLC device may refer to a function of sequentially transferring RLC SDUs received from a lower layer, to an upper layer. When a single RLC SDU is divided into multiple RLC SDUs and the divided multiple RLC SDUs are received, the in-sequence delivery function of the NR RLC device may include a function of rearranging and transferring the same.

The in-sequence delivery function of the NR RLC device may include a function of rearranging the received RLC PDUs, based on an RLC sequence number (SN) or a PDCP sequence number (SN), a function of recording lost RLC PDUs by rearranging an order, a function of reporting the state of the lost RLC PDUs to a transmission end, and a function of requesting retransmission of the lost RLC PDUs.

When there is a lost RLC SDU, the in-sequence delivery function of the NR RLC device may include a function of sequentially transferring only RLC SDUs preceding the lost RLC SDU to the upper layer.

When there is a lost RLC SDU but the timer expires, the in-sequence delivery function of the NR RLC device may include a function of sequentially transferring all RLC SDUs received before a predetermined timer starts to the upper layer.

When there is a lost RLC SDU but the predetermined timer expires, the in-sequence delivery function of the NR RLC device may include a function of transferring all RLC SDUs received up to that point in time to the upper layer.

The NR RLC device may process the RLC PDUs in the received order regardless of the order of serial numbers or sequence numbers, and may deliver the processed RLC PDUs to the NR PDCP device.

When the NR RLC device receives a segment, the NR RLC may receive segments which are stored in a buffer or are to be received later, reconfigure the segments into one complete RLC PDU, and then deliver the same to the NR PDCP device.

The NR RLC layer may not include a concatenation function and may perform the function in the NR MAC layer or may replace the function with a multiplexing function of the NR MAC layer.

In the above description, the out-of-sequence delivery function of the NR RLC device may refer to a function of directly delivering, to the upper layer regardless of order, the RLC SDUs received from the lower layer. When a single RLC SDU is divided into multiple RLC SDUs and the divided multiple RLC SDUs are received, the out-of-sequence delivery function of the NR RLC device may include a function of rearranging and transferring the divided multiple RLC SDUs. The out-of-sequence delivery function of the NR RLC device may include a function of storing the PDCP SN or the RLC SN of each of the received RLC PDUs, arranging the RLC PDUs, and recording the lost RLC PDUs.

The NR MAC 4-15 and 4-30 may be connected to several NR RLC layer devices configured in one terminal, and the main functions of the NR MAC may include some of the following functions but are not limited thereto:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

NR Physical layers (NR PHYs) 4-20 and 4-25 may generate an OFDM symbol by performing channel-coding and modulating upper-layer data and transmit the same through a radio channel, or may perform demodulating and channel-decoding the OFDM symbol received through the radio channel and transmit the same to the upper layer.

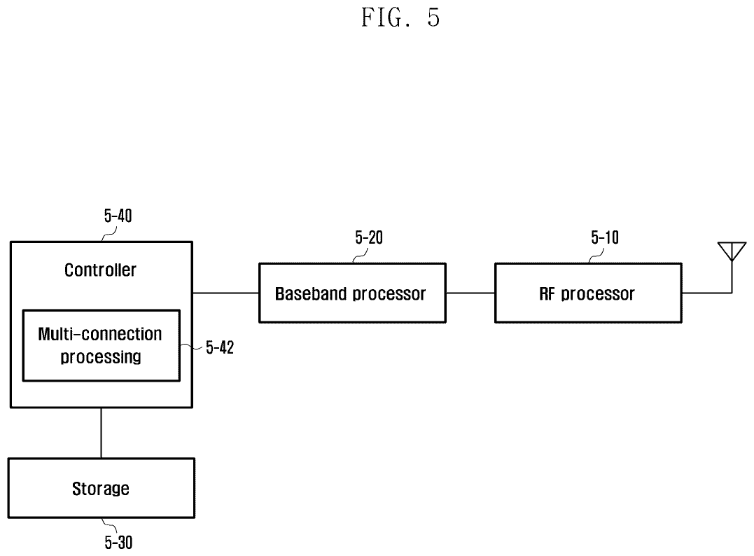

FIG. 5 illustrates a structure of a terminal in a wireless communication system according to an embodiment of the disclosure.

Referring to FIG. 5, the terminal may include a radio frequency (RF) processor 5-10, a baseband processor 5-20, a storage 5-30, and a controller 5-40.

The RF processor 5-10 may perform a function for transmitting or receiving a signal through a radio channel, such as signal band conversion, amplification, and the like. The RF processor 5-10 may up-convert a baseband signal, provided from the baseband processor 5-20, to an RF-band signal and then transmit the RF-band signal through an antenna, and down-convert an RF-band signal received through an antenna into a baseband signal. For example, the RF processor 5-10 may include a transmission filter, a reception filter, an amplifier, a mixer, an oscillator, a digital-to-analog converter (DAC), an analog-to-digital converter (ADC), and the like, but are not limited thereto. Although only a single antenna is illustrated in FIG. 5, the terminal may include multiple antennas. In addition, the RF processor 5-10 may include multiple RF chains. Furthermore, the RF processor 5-10 may perform beamforming. For beamforming, the RF processor 5-10 may adjust the phases and amplitudes of signals transmitted or received through multiple antennas or antenna elements. The RF processor 5-10 may also perform MIMO and may receive data of multiple layers of data during the MIMO operation.

The baseband processor 5-20 performs a function of conversion between a baseband signal and a bitstream according to the physical layer specifications of a system. For example, during data transmission, the baseband processor 5-20 generates complex symbols by encoding and modulating a transmission bitstream. In addition, during data reception, the baseband processor 5-20 may reconstruct a received bitstream by demodulating and decoding a baseband signal provided from the RF processor 5-10. For example, according to an orthogonal frequency-division multiplexing (OFDM) scheme, during data transmission, the baseband processor 5-20 generates complex symbols by encoding and modulating a transmission bitstream, maps the complex symbols to subcarriers, and then configures OFDM symbols by performing inverse fast Fourier transformation (IFFT) operation and cyclic prefix (CP) insertion. Further, during data reception, the baseband processor 5-20 may segment a baseband signal, provided from the RF processor 5-10, into units of OFDM symbols, reconstruct signals mapped to subcarriers by performing a fast Fourier transformation (FFT) operation, and then reconstruct a received bitstream by demodulating and decoding the signals.

The baseband processor 5-20 and the RF processor 5-10 transmit and receive signals as described above. Accordingly, each of the baseband processor 5-20 and the RF processor 5-10 may also be referred to as a transmitter, a receiver, a transceiver, or a communication unit. Furthermore, at least one of the baseband processor 5-20 and the RF processor 5-10 may include multiple communication modules to support multiple different radio-access technologies. In addition, at least one of the baseband processor 5-20 and the RF processor 5-10 may include multiple communication modules to process signals of different frequency bands. For example, the different radio-access technologies may include a wireless local area network (LAN) (e.g., IEEE 802.11), a cellular network (e.g., LTE), and the like. In addition, the different frequency bands may include a super-high frequency (SHF) (e.g., 2 GHz) band and a millimeter-wave (mmWave) (e.g., 60 GHz) band.

The storage 5-30 stores data, such as basic programs, applications, configuration information, or the like for the operation of the terminal. Specifically, the storage 5-30 may store information related to a second connection node for performing wireless communication by using a second wireless connection technology. In addition, the storage 5-30 provides the stored data in response to a request from the controller 5-40.

The controller 5-40 controls the overall operation of the terminal. For example, the controller 5-40 transmits or receives signals through the baseband processor 5-20 and the RF processor 5-10. Further, the controller 5-40 records and reads data on or from the storage 5-30. To this end, the controller 5-40 may include at least one processor. For example, the controller 5-40 may include a communication processor (CP) for controlling communication and an application processor (AP) for controlling an upper layer, such as an application.

In various embodiments, any of the RF-processor 5-10, the base band processor 5-20, and the controller 5-40 may include one or more processors or other processing devices to perform, direct, or control the disclosed functions.

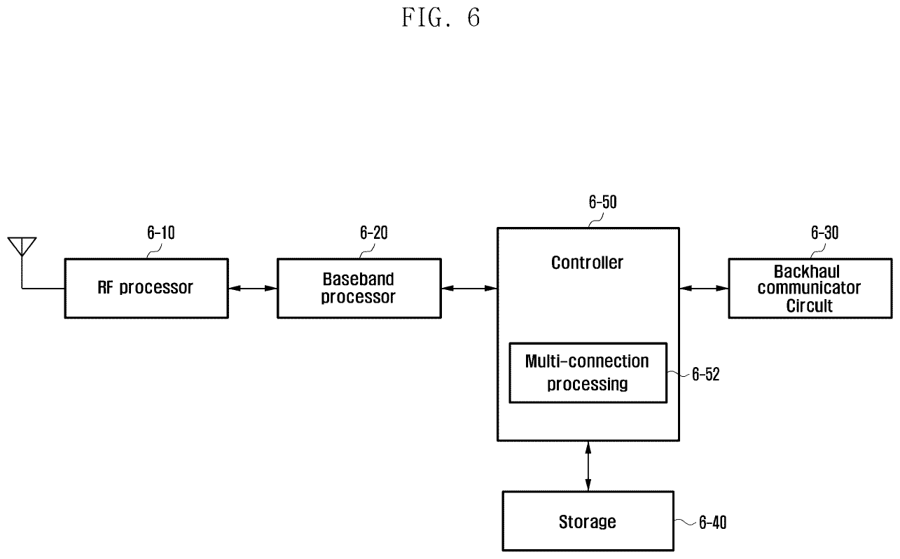

FIG. 6 illustrates configuration of a base station in a wireless communication system according to an embodiment of the disclosure.

Referring to FIG. 6, the base station may include an RF processor 6-10, a baseband processor 6-20, a backhaul communication unit 6-30, a storage 6-40, and a controller 6-50.

The RF processor 6-10 may perform a function of transmitting or receiving a signal through a radio channel, such as signal band conversion and amplification. The RF processor 6-10 up-converts a baseband signal, provided from the baseband processor 6-20, to an RF-band signal and transmits the converted RF-band signal through an antenna, and down-converts an RF-band signal received through an antenna to a baseband signal. For example, the RF processor 6-10 may include a transmission filter, a reception filter, an amplifier, a mixer, an oscillator, a DAC, an ADC, and the like. Although only a single antenna is illustrated in FIG. 6, the RF processor 6-10 may include multiple antennas. In addition, the RF processor 6-10 may include multiple RF chains. Furthermore, the RF processor 6-10 may perform beamforming. For beamforming, the RF processor 6-10 may adjust phases and amplitudes of signals transmitted or received through multiple antennas or antenna elements. The RF processor 6-10 may perform downlink MIMO operation by transmitting data of one or more layers.

The baseband processor 6-20 may perform conversion between a baseband signal and a bitstream based on the physical layer specifications of a first radio-access technology. For example, during data transmission, the baseband processor 6-20 may generate complex symbols by encoding and modulating a transmission bitstream. In addition, during data reception, the baseband processor 6-20 may reconstruct a received bitstream by demodulating and decoding a baseband signal provided from the RF processor 6-10. For example, according to an OFDM scheme, during data transmission, the baseband processor 6-20 generates complex symbols by encoding and modulating a transmission bitstream, maps the complex symbols to subcarriers, and then configures OFDM symbols by performing IFFT operation and CP insertion. Further, during data reception, the baseband processor 6-20 may segment a baseband signal, provided from the RF processor 6-10, into units of OFDM symbols, reconstructs signals mapped to subcarriers by performing FFT operation, and then reconstruct a received bitstream by demodulating and decoding the signals. The baseband processor 6-20 and the RF processor 610 may transmit and receive signals as described above. Accordingly, each of the baseband processor 6-20 and the RF processor 6-10 may also be referred to as a transmitter, a receiver, a transceiver, a communication unit, or a wireless communication unit.

The backhaul communication unit 6-30 provides an interface for communicating with other nodes in a network. For example, the backhaul communication unit 6-30 may convert a bitstream transmitted from a primary base station to another node, for example, the secondary base station, the core network, and the like, into a physical signal, and may convert a physical signal received from another node into a bitstream.

The storage 6-40 stores data, such as basic programs, applications, configuration information, or the like for the operation of the primary base station. The storage 6-40 may store information related to a bearer allocated to a connected terminal, the result of measurement reported from the connected terminal, and the like. In addition, the storage 6-40 may store information which serves as criteria for determining whether or not to provide multi-connectivity to the terminal. Further, the storage 6-40 provides the stored data in response to a request from the controller 6-50.

The controller 6-50 controls the overall operation of the base station. For example, the controller 6-50 transmits or receives a signal through the baseband processor 6-20 and the RF processor 6-10 or through the backhaul communication unit 6-30. In addition, the controller 6-50 records and reads data on or from the storage 6-40. To this end, the controller 6-50 may include at least one processor.

In various embodiments, any of the RF-processor 6-10, the base band processor 6-20, and the controller 6-50 may include one or more processors or other processing devices to perform, direct, or control the disclosed functions.

The terminal in FIG. 5 and/or base station in FIG. 6 may perform the method and/or embodiment provided in the disclosure. In addition, for example, the network controlled repeater described later may have the same or similar structure to the terminal in FIG. 5 or base station in FIG. 6.

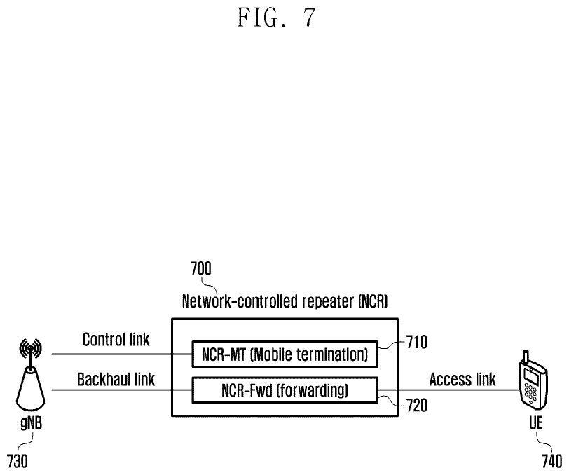

FIG. 7 illustrates a structure of a network controlled repeater (NCR) according to an embodiment of the disclosure.

With reference to FIG. 7, a network controlled repeater 700 may include an NCR-mobile termination (MT) 710 and an NCR-forwarding (FWD) 720. The NCR-MT 710 may perform the roles of receiving control signals/information for NCR operation from a serving base station 730 and transmitting the control signals/information to the NCR-FWD. The NCR-FWD 720 may perform the roles of amplifying the RF signal received from the base station 730 and transmitting the amplified RF signal to a terminal 740. Through the control signal/information received from the NCR-MT 710, the NCR-FWD 720 may perform additional operations. The NCR-FWD 720 may transmit the amplified signal to the terminal using a specific beam or receive a signal transmitted by the terminal. In addition, the NCR-FWD 720 may or may not receive/amplify/transmit a signal from the base station or receive/amplify/transmit a signal from the terminal according to a specific time division duplex (TDD) pattern. Hereinafter, the NCR-MT may be referred to as MT, and the NCR-FWD may be referred to as FWD. In addition, the connection between the base station and the NCR-MT may be referred to as control-link (C-link), the connection between the base station and the NCR-FWD may be referred to as a backhaul link, and the connection between the terminal and the NCR-FWD may be referred to as an access link.

Depending on the state in which the NCR-MT is connected to the C-link, there may be restrictions on the operation of the NCR-FWD. Therefore, it is necessary to define the operation of FWD according to a radio link monitoring (RLM) operation on the C-link of the MT.

According to an embodiment of the disclosure, the OFF operation of the NCR-FWD may be defined as not performing at least one of the following detailed operations:
The NCR-FWD does not operate to receive signals from the base station on the backhaul link;
The NCR-FWD does not amplify/transmit the received signal on the access link; and/or
The NCR-FWD may be defined as OFF at times other than a symbol section configured with an access link beam indicator of side control information (SCI) applied by the NCR-FWD.

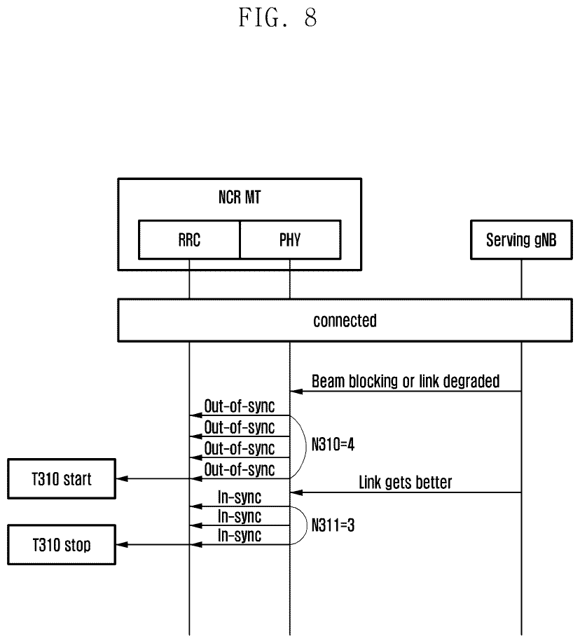

FIG. 8 illustrates a method of operation of a T310 timer according to an embodiment of the disclosure.

When measuring a reference signal for RLM measurement, in case where a signal strength exceeding a threshold associated with an in-sync indicator is measured in each time interval, the UE or MT may transmit the in-sync indicator from a physical layer to an upper layer (e.g., RRC or MAC). In addition, in each time interval, in case where the measured value does not exceed a threshold associated with an out-of-sync indicator, the UE or MT may transmit the out-of-sync indicator. For example, if beam blocking occurs or the quality of the link between the UE/MT and the base station deteriorates and a preconfigured number (e.g., N310) of consecutive out-of-sync is transmitted to the RRC layer, a T310 timer may start. Similarly, in a situation where the T310 timer has already started, if a preconfigured number (e.g., N311) of consecutive in-sync indicators is transmitted to the RRC layer, the T310 timer may be stopped. If the T310 timer runs to the end and expires, the UE or MT may declare a radio link failure (RLF).

From the perspective of NCR-MT, it may also operate in the same manner as described above, and the start of the T310 timer due to the reception of the out-of-sync indicator on the C-link may also signal a temporal link failure not only for the beam currently in use on the C-link, but also for the backhaul beam of the NCR that is configured based on the beam on the corresponding C-link.

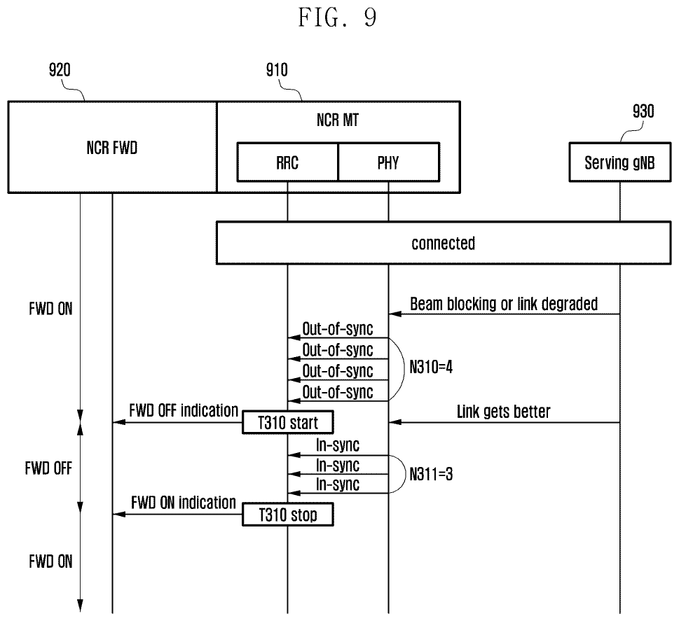

FIG. 9 illustrates an NCR-FWD operation method in conjunction with T310 timer operation according to an embodiment of the disclosure.

With reference to FIG. 9, if a RRC layer of an NCR-MT 910 continuously receives a preconfigured number (e.g., N310) of out-of-sync indicators from a PHY layer, a T310 timer may be started. Thereafter, while the T310 timer is running, if the RRC layer of the NCR-MT 910 continuously receives a preconfigured number (e.g., N311) of in-sync indicators from the PHY layer, the T310 timer may be stopped.

The NCR-MT 910 may indicate a FWD 920 to turn OFF when the T310 timer starts. The OFF indication may be performed by one of the following detailed methods as shown in options.

In one example of Opt. 1, when the RRC of the NCR MT starts the T310 timer, the RRC of the MT may indicate FWD to turn OFF. Alternatively, the MT may implicitly indicate the FWD to be OFF, or FWD itself may be turned OFF when T310 starts.

In one example of Opt. 2, when the RRC of the MT starts the T310 timer, the MT may release or remove the NCR side control information received from a base station 930. In this case, there may be differences in the OFF operation of the FWD depending on the information being released or removed.

For example, among the NCR side control information, in case where the operation configurations of the transmission/reception beams of an access link and backhaul link are all released or removed, the FWD may stop both reception and transmission operations.

For example, if the configuration information related to the beam of the access link is removed from the NCR side control information, the FWD may perform reception operation from the base station/upper node, but may stop transmission operation to the UE/lower node.

For example, if the configuration information related to the beam of the backhaul link is removed from the NCR side control information, the FWD may stop reception operation from the base station/upper node, but may perform transmission operation to the UE/lower node.

For example, among the NCR side control information, if the aperiodic beam-related configuration of the access link is removed, the FWD may stop only the aperiodic beam-related operation, excluding the semi-persistent/periodic beam operation. Here, the aperiodic beam of the access link is an example and this operation may be similarly applied to the semi-persistent/periodic beam.

In one example, Opt. 1 and Opt. 2 may also be combined. For example, when the T310 timer starts, the RRC of the MT may indicate the FWD to turn OFF and specify the configuration information released/removed among the side control information as detailed information and transmit the same to the FWD.

After the FWD is turned OFF according to the operation of the T310 timer described above, there are two methods to resume the FWD.

In one example of Method 1, a method to resume FWD ON by recognizing T310 stop operation by MT

When the T310 timer on the C-link in the MT stops, the MT may indicate the FWD to turn ON the FWD. This method of indicating ON may correspond to Opt. 1 of the method of indicating FWD OFF. Specifically, the MT may indicate ON through an RRC signal, or implicitly indicate ON of the FWD, or the FWD itself may be turned ON when the T310 timer stops.

In this case, the FWD may be operated using the latest side control information (i.e., the most recent side control information before the T310 start). Specifically, the FWD may be operated using the following configuration information:

Using access link beam configuration:
for periodic beam: FWD may forward (resume) the received signal over each indicated beam and its corresponding time resource (symbol position in time, and symbol duration for forwarding), and/or
for aperiodic beam: over the latest indicated beam (before BF) by DCI can be used for forwarding the received signal over, using the time resource configured before BF;

Using backhaul link beam configuration:
Semi-static beam: FWD may use the UL/DL beam indicated by MAC CE before BF, and/or
Adaptive beam: FWD use latest indicated by MAC CE and/or DCI for the adaptive beam before BF; and/or.
All the time resource to be used is just after the BFR indicated time.

In case where the previous OFF operation of the FWD is performed on the basis of the Opt. 2 (for example, in case where the specific configuration information of the side control information has been released), Method 1 above may not be used. In other words, in case where the OFF operation of the FWD is performed based on Opt. 1, Method 1 above may be used upon resumption of FWD ON.

The above scheme may be a handling scheme in case where the T310 timer stops in case where consecutive in-sync indicators are received. In the case of T310 stop due to other conditions, for example, in the following cases, FWD OFF may be maintained instead of FWD ON:
Reception of a handover (HO) indicator,
Reception of an inter radio access technology (RAT) HO indicator,
Performance of conditional reconfiguration,
upon the reconfiguration of rlf-TimersAndConstant,
upon initiating RRC reestablishment, and/or
upon master cell group (MCG) failure information procedure.

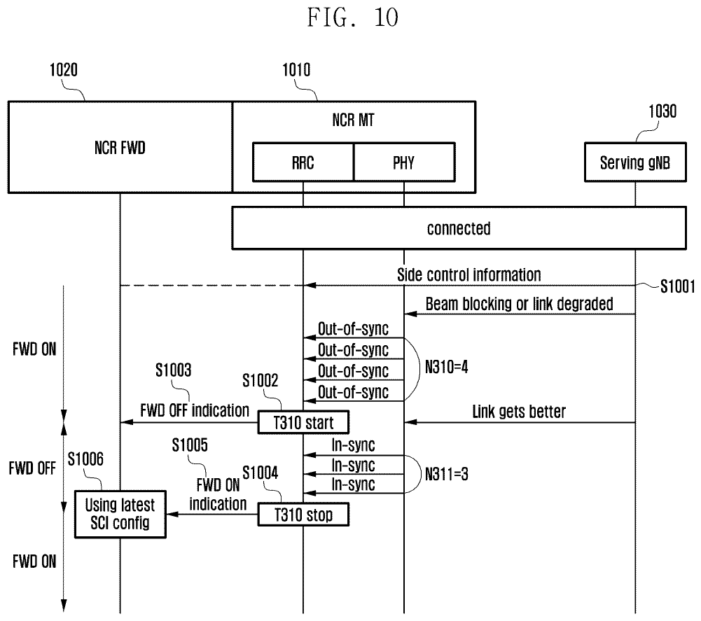

FIG. 10 illustrate a method for resuming a FWD ON operation according to an embodiment of the disclosure.

The operations in FIG. 10 may be performed on the basis of Opt. 1 and Method 1 described above. With reference to FIG. 10, the ON operation may be resumed using the FWD configuration information maintained by the NCR node.

With reference to FIG. 10, an NCR-MT 1010 may receive side control information from a base station 1030 in operation S1001. In operation S1002, if the RRC layer of the NCR-MT 1010 continuously receives a preconfigured number (e.g., N310) of out-of-sync indicators from a PHY layer, the T310 timer may start. In operation S1003, the NCR-MT 1010 may indicate a FWD 1020 to turn OFF when the T310 timer starts. The OFF indication may be based on Opt. 1 described above. In operation S1004, if the RRC layer of the NCR-MT 1010 continuously receives a preconfigured number (e.g., N311) of in-sync indicators from the PHY layer while the T310 timer is running, the T310 timer may stop. In operation S1005, when the T310 timer stops, the NCR-MT 1010 may indicate the FWD 1020 to turn FWD ON. In this case, in operation S1006, the FWD 1020 may operate the FWD using the latest side control information (i.e., the most recent side control information before the T310 start).

In one example of Method 2, a method to resume FWD ON from a network.

In case where the MT recognizes the stop of the T310 timer, the FWD may still remain in the OFF state regardless of the stop point. However, after the stop of the T310 timer, the network provides separate side control information, and at the same time, the FWD may resume ON.

Depending on the type of side control information transmitted, the FWD may perform the following operations:

New side control information for access link configuration via DL RRC message (msg):
In this case, the beam indicated by the periodic beam of the access link may be turned on for the indicated time;

New side control information for backhaul link configuration via DL RRC msg:
In this case, the beam indicated by the semi-static beam of the backhaul link may be turned ON for the indicated time; and/or

In case where the MT is configured with MAC CE/DCI to use a specific beam in a situation in which the configuration of the beam to be used on the existing C-link has already been transmitted to the RRC, or the configuration of the new C-link beam has been transmitted to the MT through the RRC after the stop of the T310 timer, even if separate MAC CE and/or DCI for the semi-static beam of the backhaul link are not received, the currently used beam on the C-link may be used as the semi-static and/or adaptive beam of the NCR backhaul link.

In addition, each access link beam configuration and backhaul link beam configuration information may follow the following detailed operations:

Using access link beam configuration:
For periodic/semi-persistent beam: FWD may use the new configured beams and corresponding time resources by new (the first) RRC msg after T310 stop, and/or
For aperiodic beam: beams indicated by newly received DCI after T310 stop, and which is also among set of beams indicated by RRC msg received after T310 stop; and/or

Using backhaul link beam configuration:
Semi-static beam: FWD may use the UL/DL beam indicated by MAC CE received after T310 stop, and/or
Adaptive beam: FWD may use indicated by MAC CE and/or DCI received after T310 stop.

In addition, after the stop of the T310 timer, the MT may transmit, to the base station, a signal that includes/or indicates that there has been a temporal link failure and/or that the temporal link failure has recovered. This signal may be transmitted through a UL RRC message or UL MAC CE or uplink control information (UCI). The base station, which has received this signal, may transmit the resulting new backhaul link and/or access link configuration information to the MT.

According to another embodiment, when FWD is turned off, in case where the MT does not remove the existing side control information configuration information (Opt. 1), the network may indicate the FWD On indicator to the terminal through DL RRC, DL MAC CE, or DCI. In this case, the FWD On may be resumed by applying the most recent side control information as the access/backhaul beam configuration.

In case where the MT receives new side control information of the network or an indication/message for FWD On, the MT may indicate the FWD to ON or resume On through a separate signal (e.g., RRC).

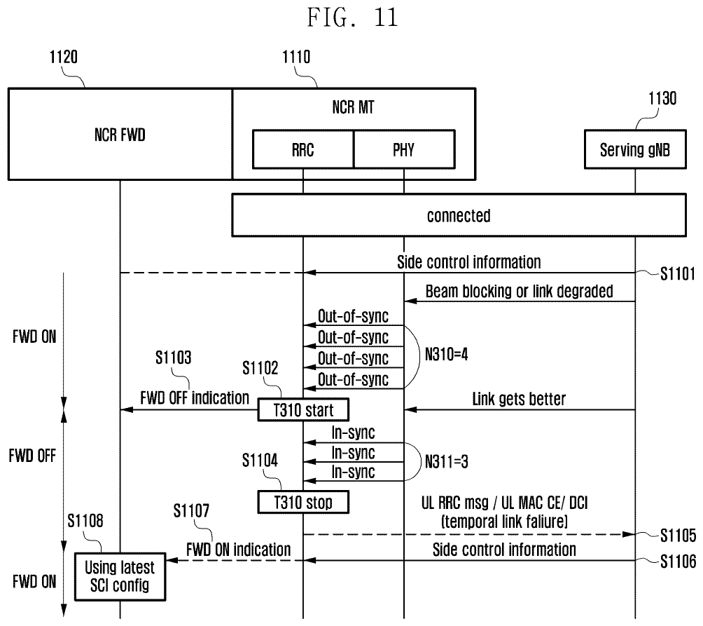

FIG. 11 illustrates another method for resuming a FWD ON operation according to an embodiment of the disclosure.

The operations in FIG. 11 may be performed on the basis of Opt. 2 and Method 2 described above.

With reference to FIG. 11, an NCR-MT 1110 may receive side control information from a base station 1130 in operation S1101. In operation S1102, if the RRC layer of the NCR-MT 1110 continuously receives a preconfigured number (e.g., N310) of out-of-sync indicators from a PHY layer, the T310 timer may start. In operation S1103, the NCR-MT 1110 may indicate a FWD 1120 to turn OFF when the T310 timer starts. The OFF indication may be performed based on Opt. 1 or Opt. 2 described above. In operation S1104, if the RRC layer of NCR-MT 1110 continuously receives a preconfigured number (e.g., N311) of in-sync indicators from the PHY layer while the T310 timer is running, the T310 timer may stop. In this case, the FWD 1120 may remain in the Off state. In operation S1105, the NCR-MT 1110 may transmit information about temporal link failure to a base station 1130. In some cases, operation S1105 may not be performed. In operation S1106, the base station 1130 may transmit new side control information to the NCR-MT 1110. If new side control information is received after the stop of the T310 timer, the FWD 1120 may resume ON. For example, as in operation S1107, the NCR-MT 1110 may indicate the FWD 1102 to turn FWD ON. In some cases, operation S1107 may be omitted. In S1108 operation, the FWD 1120 may operate the FWD using the latest side control information.

Hereinafter, FWD ON/OFF operations according to various states of the MT and a method for maintaining or releasing the associated FWD configuration information is provided.

In the case of turning the FWD OFF or performing an OFF operation, when the network transmits side control information (SCI), if specific or all FWD-related configuration information is released and transmitted, the FWD may regard the case of time when there is no configuration for operation at a specific time as the OFF operation.

In addition, as in the case of T310 above, there may be a case where the FWD is turned OFF not by the network but by the MT itself. In the case of this self-OFF operation, a decision may be made as to whether to store or release the SCI configuration of the network in the MT, FWD, or NCR node.

Since the majority of MT autonomous OFFs occur when the SCI cannot be received directly from the network due to a problem in the C-link, the SCI may not be received immediately when transitioning from OFF to ON. (For example, the network may not recognize the C-link problems). Accordingly, in order to resume the operation of the FWD as quickly as possible and validate the service of the serving terminals, the MT or FWD or NCR node may maintain the SCI or FWD-related configuration information even when the MT is autonomous OFF. This operation may be applied in the following cases:
In case where the MT detects beam failure on C-link, when the FWD is turned OFF;
In case where the T310 timer starts during RLM on the C-link of the MT, when the FWD is turned OFF;
When the MT transitions to the inactive/idle state, or when cell reselection is transitioned to a cell other than the cell that has received the SCI in the existing connection mode after transition is performed; or
When RLF is declared.

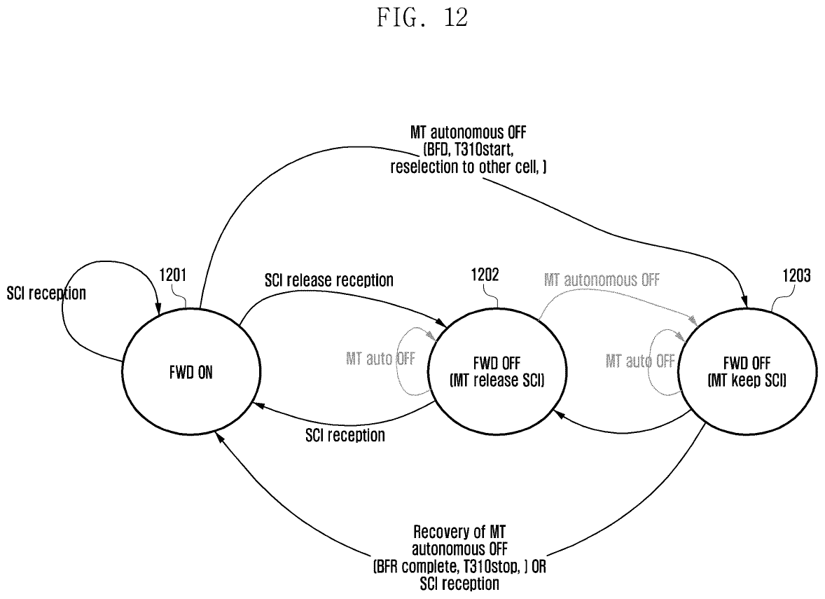

FIG. 12 illustrates a method of maintaining configurating information for an ON/OFF state of FWD according to an embodiment of the disclosure.

With reference to FIG. 12, when SCI is received in a FWD ON state (1201), the FWD ON state is still in place. When the SCI is released in the FWD ON state, the FWD becomes OFF state (1202) without SCI. when the SCI is received in the FWD OFF state without the SCI, the FWD may become ON (1201) again. When the MT autonomous OFF operation is performed in the FWD On state (1201) (e.g., beam failure detection (BFD), T310 starts, reselection to other cell(s)), the FWD becomes the OFF state (1203), and in this case, as in the method provided in the disclosure, the SCI of FWD may be kept. In this state, when the MT autonomous OFF operation is recovered (e.g., beam failure recovery (BRF) complete, T310 stop), the FWD ON state (1201) may be reached based on the kept SCI.

Among the configuration information included in the SCI, the beam of the backhaul link and access link indicated by RRC and the usage time information of the beam are configured to indicate the FWD ON operation, but when the FWD is turned OFF, until the FWD On is performed again based on the existing configuration information after that, the beam and the information about the usage time of the beam in the configuration information in the corresponding SCI may be considered OFF.

Table 1 shows examples of parameters for configuring periodic forwarding resources.

For example, in the case of periodic beams among access link beams, the initially configured ON time/resources may be subject to additional restrictions in ON/OFF operation due to the OFF operation of FWD. For example, if the MT indicates FWD OFF, the NCR-FWD may be assumed to be FWD OFF until FWD ON is indicated even if “beamIndex” is

TABLE 1
NCR-PeriodicFwdResourceSet field descriptions

durationInSymbols
Indicates the time duration in number of symbols.
beamIndex
Indicates logical beam index for NCR-FWD access link. NCR-FWD is
assumed to be ON over the indicated time domain resource if there
is beam indication. If MT indicates FWD OFF, NCR-FWD is assumed
to be OFF even this indication exists, until MT indicates FWD ON.

In an embodiment, an indication message for the RRC operation of the NCR-MT indicated by the network may include FWD configuration information or an indicator to keep or release SCI and be transmitted to the MT. For example, if the RRCRelease message or RRCRelease with suspendConfig message includes an indicator to release or keep NCR configuration information, FWD configuration information or SCI and is transmitted to the MT, the MT may release or keep the corresponding configuration information when transitioning to an idle mode or inactive mode. For reference, in the idle mode, all radio resource-related information of the MT is released. In this case, the FWD configuration information may be excluded from release. Thereafter, in case where the MT reselects a cell to another cell, an operation to release the FWD configuration information may be performed as an MT internal operation.

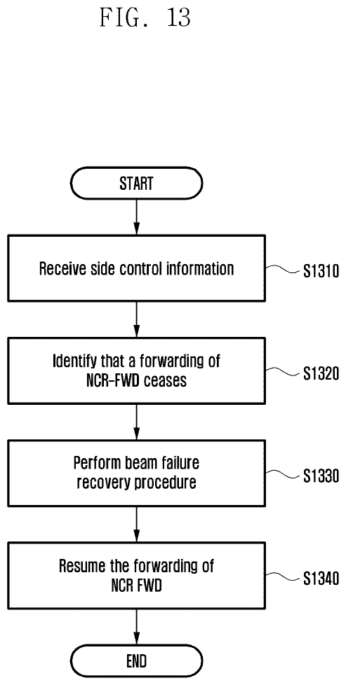

FIG. 13 illustrates a flowchart of a method for NCR according to an embodiment of the disclosure.

With reference to FIG. 13, the NCR may include an NCR-MT and an NCR-FWD, similar to the structure of the NCR in FIG. 7 described above. The order in FIG. 13 may be changed, and some operations may be omitted or two or more operations may be combined and performed as one operation.

In operation S1310, the NCR may receive side control information from the base station. The side control information may include FWD configuration information. For example, the side control information may include configuration for periodic resources for forwarding, and the configuration for the periodic resources may include beamindex and/or durationinsymbols parameters. For example, the side control information may be received through a control link between the base station and the NCR-MT.

In operation S1320, the NCR may identify that forwarding of NCR-FWD has stopped. The stop of forwarding (i.e., FWD OFF) may be indicated to the NCR-FWD based on at least one of the above-described Opt. 1 and Opt. 2. For example, if a beam failure for the NCR-MT is detected, the NCR-FWD may be indicated to stop forwarding based on the beam failure detection. If forwarding is stopped, the NCR-FWD may stop at least one of transmission and reception on the backhaul link and transmission and reception on the access link.

If forwarding is stopped based on the beam failure detection, the NCR may perform a beam failure recovery procedure in operation S1330.

In operation S1340, the NCR-FWD may be turned ON and forwarding may be resumed. For example, the NCR may resume forwarding based on the side control information received before the beam failure detection.

The above-described embodiments and methods of the disclosure may be performed in combination with each other.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable read only memory (EEPROM), a magnetic disc storage device, a CD-ROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

In the specific embodiments of the disclosure described above, components included in the disclosure are expressed in singular or plural numbers depending on the specific embodiment presented. However, singular or plural expressions are selected to suit the presented situation for convenience of explanation, and the disclosure is not limited to singular or plural components, and even components expressed in plural may be composed of singular or singular. Even expressed components may be composed of plural elements.

Meanwhile, in the detailed description of the disclosure, specific embodiments have been described, but of course, various modifications are possible without departing from the scope of the disclosure. Therefore, the scope of the disclosure should not be limited to the described embodiments, but should be determined not only by the scope of the claims described later, but also by the scope of this claims and equivalents.

Although the disclosure has been described with various embodiments, various changes and modifications may be suggested to one skilled in the art. It is intended that the disclosure encompass such changes and modifications as fall within the scope of the appended claims.

What is claimed is:

1. A method performed by a network controlled repeater (NCR) including an NCR mobile termination (NCR-MT) and an NCR forwarding (NCR-FWD) in a wireless communication system, the method comprising:
receiving, by the NCR-MT, side control information from a base station;
detecting a beam failure for the NCR-MT;
ceasing, by the NCR-FWD, a forwarding based on a detection of the beam failure;
identifying a completion of a beam failure recovery; and
resuming the forwarding using the side control information received before the detection of the beam failure based on the completion of the beam failure recovery.

2. The method of claim 1, wherein the side control information is received via a control link between the base station and the NCR-MT.

3. The method of claim 1, wherein the side control information includes configuration information for periodic forwarding resources, and
wherein the configuration information includes a beam index indicating a logical beam index for an NCR-FWD access link.

4. The method of claim 3, wherein, in case that the forwarding ceases, the NCR-FWD is disabled regardless of the beam index.

5. The method of claim 1, further comprising:
receiving, via a medium access control-control element (MAC-CE) signaling, information on a downlink beam and information on an uplink beam for a backhaul link,
wherein the backhaul link connects the base station with the NCR-FWD of the NCR.

6. The method of claim 5, wherein, in case that the forwarding ceases, at least one of a transmission on the backhaul link or a transmission on an access link between a terminal and the NCR-FWD stops.

7. A method performed by a base station in a wireless communication system, the method comprising:
transmitting, to a network controlled repeater (NCR) including an NCR mobile termination (NCR-MT) and an NCR forwarding (NCR-FWD), side control information,
wherein a forwarding ceases based on a beam failure detection between the base station and the NCR-MT,
wherein a beam failure recovery is performed between the base station and the NCR, and
wherein the forwarding is resumed using the side control information transmitted before the beam failure detection based on a completion of the beam failure recovery.

8. The method of claim 7, wherein the side control information is transmitted via a control link between the base station and the NCR-MT of the NCR.

9. The method of claim 7, wherein the side control information includes configuration information for periodic forwarding resources, and
wherein the configuration information includes a beam index indicating a logical beam index for an access link connected to the NCR-FWD.

10. The method of claim 7, further comprising:
transmitting, to the NCR via medium access control-control element (MAC-CE) signaling, information on a downlink beam and information on an uplink beam for a backhaul link,
wherein the backhaul link connects the base station with the NCR-FWD of the NCR.

11. A network controlled repeater (NCR) including an NCR mobile termination (NCR-MT) and an NCR forwarding (NCR-FWD) in a wireless communication system, the NCR comprising:
a transceiver; and
at least one processor configured to:
receive, from a base station, side control information,
detect a beam failure for the NCR-MT,
cease a forwarding based on a detection of the beam failure,
identify a completion of a beam failure recovery, and
resume the forwarding using the side control information received before the detection of the beam failure based on the completion of the beam failure recovery.

12. The NCR of claim 11, wherein the side control information is received via a control link between the base station and the NCR-MT.

13. The NCR of claim 11, wherein the side control information includes configuration information for periodic forwarding resources,
wherein the configuration information includes a beam index indicating a logical beam index for an NCR-FWD access link, and
wherein, in case that the forwarding ceases, the NCR-FWD is disabled regardless of the beam index.

14. The NCR of claim 11, wherein the at least one processor is further configured to receive, via medium access control-control element (MAC-CE) signaling, information on a downlink beam and information on an uplink beam for a backhaul link, and wherein the backhaul link connects the base station with the NCR-FWD of the NCR.

15. Abase station (BS) in a wireless communication system, the BS comprising:
a transceiver; and
at least one processor configured to:
transmit, to a network controlled repeater (NCR) including an NCR mobile termination (NCR-MT) and an NCR forwarding (NCR-FWD), side control information,
wherein a forwarding ceases based on a beam failure detection between the base station and the NCR-MT,
wherein a beam failure recovery is performed between the base station and the NCR, and
wherein the forwarding is resumed using the side control information transmitted before the beam failure detection based on a completion of the beam failure recovery.

16. The BS of claim 15, wherein the side control information is transmitted via a control link between the base station and the NCR-MT of the NCR.

17. The BS of claim 15, wherein the side control information includes configuration information for periodic forwarding resources, and
wherein the configuration information includes a beam index indicating a logical beam index for an access link connected to the NCR-FWD.

18. The BS of claim 15, wherein the at least one processor is further configured to:
transmit, to the NCR via medium access control-control element (MAC-CE) signaling, information on a downlink beam and information on an uplink beam for a backhaul link, and
wherein the backhaul link connects the base station with the NCR-FWD of the NCR.
